(19) United States
(12) Patent Application Publication
(10) Pub. No.: US 2025/0319778 A1
(43) Pub. Date: Oct. 16, 2025

(54) STATIONARY VEHICLE BATTERY CHARGER FOR BATTERY ELECTRIC VEHICLE

(71) Applicant: BorgWarner Inc., Auburn Hills, MI (US)

(72) Inventors: Luca Di Carlo, Royal Oak, MI (US); Brian C. Wightman, Davisburg, MI (US)

(21) Appl. No.: 18/631,292

(22) Filed: Apr. 10, 2024

(51) Int. Cl. B60L 53/10; B60L 53/18

(52) U.S. Cl. CPC B60L 53/11; B60L 53/18; B60L 2210/30

(57) ABSTRACT

A stationary vehicle charging system for charging batteries carried by battery electric vehicles (BEVs) includes a plurality of power modules configured to receive alternating current (AC) voltage from an electrical grid and rectify the AC voltage into direct current (DC) voltage; a primary group of switches having switches electrically coupled: to the plurality of power modules, with other switches within the primary group of switches via a plurality of primary module busses, and to a charging cable for charging a BEV; and a secondary group of switches having switches electrically coupled to: a plurality of switches within the primary group of switches, with another charging cable for charging a BEV, and configured to electrically couple to one or more secondary busses.

### TECHNICAL FIELD

The present application relates to battery electric vehicle (BEV) charging and, more particularly, to stationary charging stationary vehicle battery chargers used to charge BEVs.

### BACKGROUND

Battery electric vehicles (BEVs) are occupying an increasing share of new vehicle sales. As BEVs become more ubiquitous, so too will be the presence of stationary vehicle battery chargers to provide charge to the batteries carried by the BEVs. The increase in availability of stationary vehicle battery chargers will coincide with pressures to reduce the cost of manufacturing the chargers. Currently, the components included in a stationary vehicle battery charger and assembly of those components involves significant expense. It would be helpful to reduce the number of components included in the stationary vehicle battery charger.

### SUMMARY

In one implementation, a stationary vehicle charging system for charging batteries carried by battery electric vehicles (BEVs) includes a plurality of power modules configured to receive alternating current (AC) voltage from an electrical grid and rectify the AC voltage into direct current (DC) voltage; a primary group of switches having switches electrically coupled: to the plurality of power modules, with other switches within the primary group of switches via a plurality of primary module busses, and to a charging cable for charging a BEV; and a secondary group of switches having switches electrically coupled to: a plurality of switches within the primary group of switches, with another charging cable for charging a BEV, and configured to electrically couple to one or more secondary busses.

In another implementation, a stationary vehicle charging system for charging batteries carried by BEVs includes a plurality of power modules configured to receive alternating current (AC) voltage from an electrical grid and rectify the AC voltage into direct current (DC) voltage; a first dispenser, including some of the plurality of power modules, having a first housing, electrically coupled to at least one charging cable for charging a BEV; a second dispenser, including some of the plurality of power modules, having a second housing, electrically coupled to at least one charging cable for charging a BEV; a primary group of switches in the first dispenser electrically coupled: to the plurality of power modules in the first dispenser, with other switches within the primary group of switches located in the first dispenser via a plurality of primary module busses; a secondary group of switches in the first dispenser having switches electrically coupled to: a plurality of switches within the primary group of switches in the first dispenser and configured to electrically couple to one or more secondary busses; a primary group of switches in the second dispenser electrically coupled: to the plurality of power modules in the second dispenser, with other switches within the primary group of switches located in the second dispenser via a plurality of primary module busses; and a secondary group of switches in the second dispenser having switches electrically coupled to: a plurality of switches within the primary group of switches in the second dispenser and the secondary group of switches in the first dispenser.

In yet another implementation, a stationary vehicle charging system for charging batteries carried by BEVs including a first power module and a second power module configured to receive alternating current (AC) voltage from an electrical grid and rectify the AC voltage into direct current (DC) voltage; a primary group of seven switches, such that: three of the switches are electrically coupled the first power module, four of the switches are electrically coupled to the second power module, wherein one of the switches electrically coupled to the second power module is also directly coupled to a charging cable for charging a BEV; a plurality of primary module busses electrically connecting the primary group of seven switches; and a secondary group of three switches electrically coupled to the plurality of primary module busses and configured to electrically couple to one or more secondary busses.

### BRIEF DESCRIPTION OF THE DRAWINGS

FIG. 1 is a block diagram depicting an implementation of an electrical system including an electrical grid, a battery electric vehicle (BEV), and a stationary vehicle battery charger;

FIG. 2 is a block diagram depicting an implementation of a stationary vehicle battery charger for charging a vehicle battery on a BEV; and

FIG. 3 is a block diagram depicting another implementation of a stationary vehicle battery charger for charging a vehicle battery on a BEV.

### DETAILED DESCRIPTION

Stationary vehicle battery chargers generally receive alternating current (AC) voltage from an electrical grid, rectify the AC voltage into DC voltage, and provide the DC voltage directly to a battery carried by a battery electric vehicle (BEV). The stationary vehicle battery chargers include power modules that can carry out the rectification of AC voltage into DC voltage. The stationary vehicle battery chargers often include the ability to charge a plurality of BEVs simultaneously. However, as the quantity of simultaneously charging BEVs increases, so too does the quantity of electrical components included in stationary vehicle battery charger. Past stationary vehicle battery chargers have typically used a quantity of switches or contactors that equals the quantity of power modules used to rectify the AC voltage multiplied by the quantity of charging cables available to charge BEVs. For example, a stationary vehicle battery charger offering six charging cables for charging BEVs and including six power modules would rely on thirty-six switch pairs to carry out BEV charging.

In contrast, the proposed stationary vehicle battery charger described here includes a primary group of switches electrically coupled to a plurality of power modules that rectify AC voltage received from the grid into DC voltage. The switches, and reference to the term switches, can refer to two discrete switches-one positive switch and one negative switch. The primary group of switches can also be electrically coupled to a secondary group of switches and primary module busses. The secondary group of switches can be electrically coupled to a plurality of charging cables that are capable of detachably coupling to BEVs via charging plugs to provide charge to the vehicle batteries carried by the BEVs as well as one or more secondary electrical busses that electrically couple one or more switches within the secondary group of switches to other switches. The primary group of switches can function to connect a power module to a specific charging cable or a specific primary bus whereas the secondary group of switches can connect different primary and secondary busses. The arrangement of the switches in a primary group and a secondary group as described herein can yield a circuit that charges n number of vehicles with fewer than n by n number of switches and charging cables, respectively, that are available to connect to BEVs.

The primary group of switches can electrically connect an individual power module to a particular charging cable while the secondary group of switches can electrically connect one electrical bus with another bus. The control of the primary group of switches and the secondary group of switches can be influenced by a desired power output at a particular electrical cable coupled to a BEV such that the power output is variable. That is, different switches from the primary group of switches and the secondary group of switches can be selectively rendered conductive to deliver a particular electrical power output at a particular electrical cable coupled to a BEV. The selective conductivity of the switches can permit the use of switches that may be have an electrical specification with a rating below that which may have been used in the past. That is, the switch may be able to sustain a heightened electrical power level for a short duration that would exceed an electrical power level that the switch could maintain for long time durations. The selective conductivity of switches can preserve and prolong the switch life by minimizing heat and load on the switches. For example, one electrical cable can receive DC voltage through switches from both the primary group and the secondary group; the conductivity of the switches connects three separate power modules to the cable thereby spreading the power load across multiple electrical components. In one implementation, two power modules can be electrically connected to seven switches in the primary group and three switches in the secondary group.

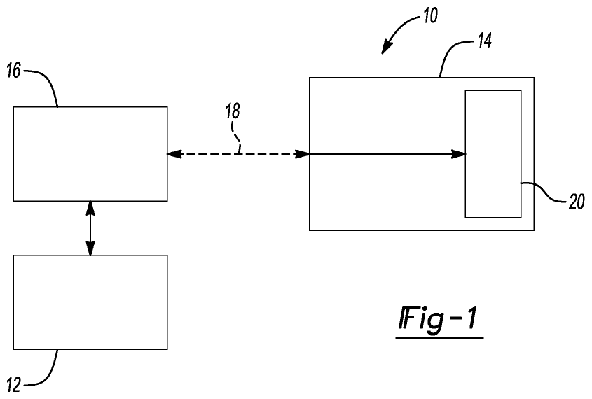

Turning to FIG. 1, an implementation of an electrical system 10 is shown including an electrical grid 12 and a battery electric vehicle (BEV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase 50-60 Hz. However, this voltage range can be different.

A stationary vehicle battery charger 16 can receive AC electrical power from the grid 12, rectify the AC electrical power into DC electrical power, and provide the DC electrical power to the BEV 14. The Stationary vehicle battery charger 16 can be geographically fixed, such as a charging station located in a vehicle garage or in a vehicle parking lot. The stationary vehicle battery charger 16 can include an input terminal that receives the AC electrical power from the grid 12 and communicates the AC electrical power to a BEV battery 20 directly, bypassing an on-board vehicle battery charger included on the BEV 14. A charging cable 18 can use a charging plug to detachably connect with an electrical receptacle on the BEV 14 and electrically link the stationary vehicle battery charger 16 with the BEV 14 so that DC electrical power can be communicated between the stationary vehicle battery charger 16 and the BEV battery 20. The stationary vehicle battery charger 16 can include a plurality of charging cables 18 to charge a plurality of BEVs 14 at the same time. The stationary vehicle battery charger 16 can receive 480 VAC from the grid 12 and have a power rating of greater than 60 kW provided to the BEV 14. This configuration may be referred to as DC fast charging or Level 3 EV charging. However, the stationary vehicle battery charger 16 can be implemented using different standards. The term “battery electric vehicle” or “BEV” can refer to vehicles that are propelled, either wholly or partially, by electric motors. BEV can refer to electric vehicles, plug-in electric vehicles, hybrid-electric vehicles, and battery-powered vehicles. It should be viewed as encompassing passenger vehicles as well as commercial vehicles.

The BEV battery 20 can supply DC electrical power controlled by power electronics to the electric motors that propel the BEV 14. The BEV battery 20 or batteries are rechargeable and can include lead-acid batteries, nickel cadmium (NiCd), nickel metal hydride, lithium-ion, and lithium polymer batteries, to provide a few examples. A typical range of vehicle battery voltages can range from 1000 to 1500V of DC electrical power (VDC). A control system, implemented as computer-readable instructions executable by a microprocessor, can be stored in non-volatile memory and called on to control functionality of the stationary vehicle battery charger 16 such that the microprocessor includes computer-readable instructions that execute a control scheme for controlling the switches included in the power modules, the primary group of switches, and the secondary group of switches. The microprocessor can include a plurality of control outputs linked to the gate inputs of the switches to selectively render the switches conductive. This will be discussed in more detail below.

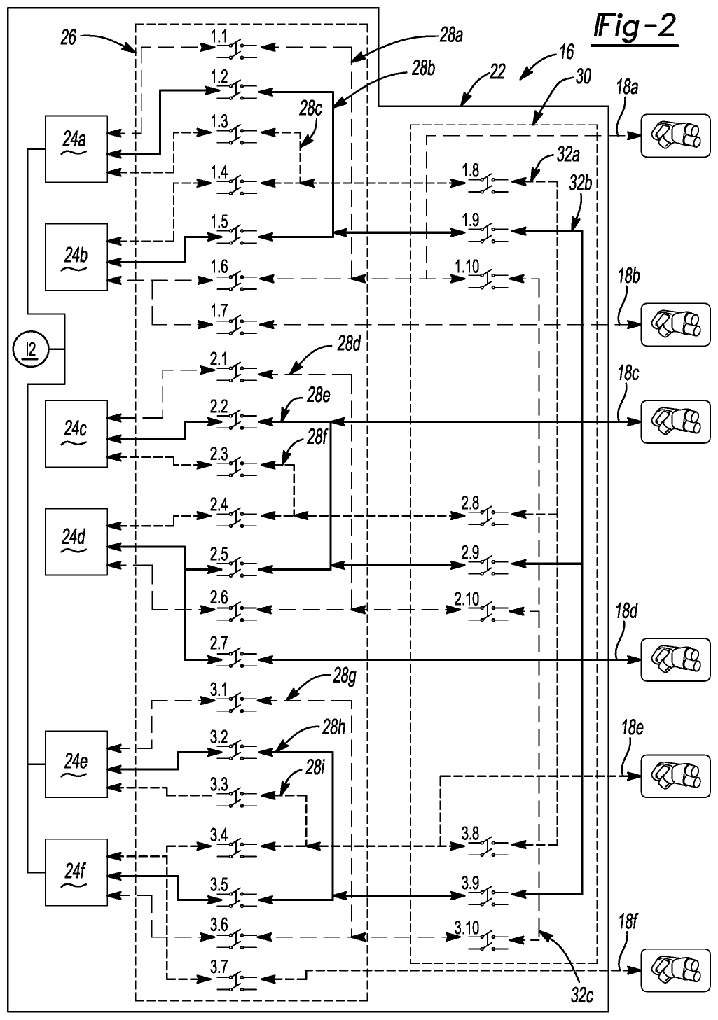

FIG. 2 depicts an implementation of the stationary vehicle battery charger 16 enclosed within a single housing 22 that includes a plurality of power modules 24a-f electrically coupled to a plurality of charging cables 18a-18f capable of electrically connecting to BEVs 14 to charge the BEV battery 20. In this implementation, the stationary vehicle battery charger 16 includes six power modules 24a-f receiving AC voltage from the electric grid 12 and also electrically connected to a primary group of switches 26. The power modules 24a-f can receive AC voltage from the electrical grid 12 and rectify the AC voltage into DC voltage that can be directly applied to the BEV battery 20. A number of different types of power modules could be used in the stationary vehicle battery charger 16. For example, one possible power module is a multistage isolated AC-DC power module made from silicon carbide (SiC). Each power module 24a-f can include 6 switches (not shown) used as a power factor correction (PFC) front end and 4 switches (not shown) used as an isolated DC-DC Converter having gates that are electrically connected to a microprocessor. The switches described here can also be implemented using bipolar junction transistors (BJTs) or field effect transistors (FETs), such as insulated gate bipolar transistors (IGBTs), metal-oxide-semiconductor field effect transistors (MOSFETs), or gallium nitride transistors (GaN). The switches can be bidirectional or reverse-blocking such that they are four-quadrant switches capable of conducting positive or negative on-state current and blocking positive or negative off-state voltage.

The primary group of switches 26 include a plurality of switches that are electrically coupled to the power modules 24a-f. In this implementation, groups of two power modules 24a-f are electrically coupled to seven switches 1.1-3.7 included in the primary group of switches 26. For example, power modules 24a and 24b can be electrically coupled to switches 1.1-1.7, power modules 24c and 24d can be electrically coupled to switches 2.1-2.7, and power modules 24e and 24f can be electrically coupled to switches 3.1-3.7. The two power modules 24a, 24b can also be electrically connected via a primary module bus 28a. For example, switches 1.1 and 1.6 can be electrically coupled via a primary module bus 28a, switches 1.2 and 1.5 can be electrically coupled via another primary module bus 28b, and switches 1.3 and 1.4 can be electrically coupled via yet another primary module bus 28c. A similar configuration can be used with power modules c-f and switches 2.1-2.7 and 3.1-3.7 such that switches 2.1 and 2.6 can be electrically coupled via a primary module bus 28d, switches 2.2 and 2.5 can be electrically coupled via another primary module bus 28e, and switches 2.3 and 2.4 can be electrically coupled via yet another primary module bus 28f. Switches 3.1 and 3.6 can be electrically coupled via a primary module bus 28g, switches 3.2 and 3.5 can be electrically coupled via another primary module bus 28h, and switches 3.3 and 3.4 can be electrically coupled via yet another primary module bus 28i. Switches 1.6 and 1.7, 2.5 and 2.7, and 3.4 and 3.7 can be electrically connected to each other in parallel. Switch 1.7 can be directly coupled to electrical cable 18b, switch 2.2 can be directly coupled to charging cable 18c, switch 2.7 can be directly coupled to charging cable 18d, and switch 3.7 can be directly coupled to charging cable 18f.

The switches 1.1-1.7, 2.1-2.7, 3.1-3.7 included in the primary group of switches 26 can also be electrically coupled to a secondary group of switches 30. Switches 1.8-1.10, 2.8-2.10, and 3.8-3.10, respectively, in the secondary group of switches 30 can electrically couple with the power modules 24a-f through the primary group of switches 26, a secondary bus 32a-32c, or directly to a charging cable 18. In this implementation, the switch 1.8 can electrically couple with primary module bus 28c, the switch 1.9 can electrically couple with primary module bus 28b, and the switch 1.10 can electrically couple with primary module bus 28a. The switch 2.8 can electrically couple with primary module bus 28f, the switch 2.9 can electrically couple with primary module bus 28e, and the switch 2.10 can electrically couple with primary module bus 28d. The switch 3.8 can electrically couple with primary module bus 28i, the switch 3.9 can electrically couple with primary module bus 28h, and the switch 3.10 can electrically couple with primary module bus 28g. Switch 1.10 can be electrically coupled to charging cable 18a and switch 3.8 can be electrically coupled to charging cable18e. Secondary bus 32a can electrically couple switches 1.8, 2.8, and 3.8; secondary bus 32b can electrically couple switches 1.9, 2.9, and 3.9; secondary bus 32c can electrically couple switches 1.10, 2.10, and 3.10.

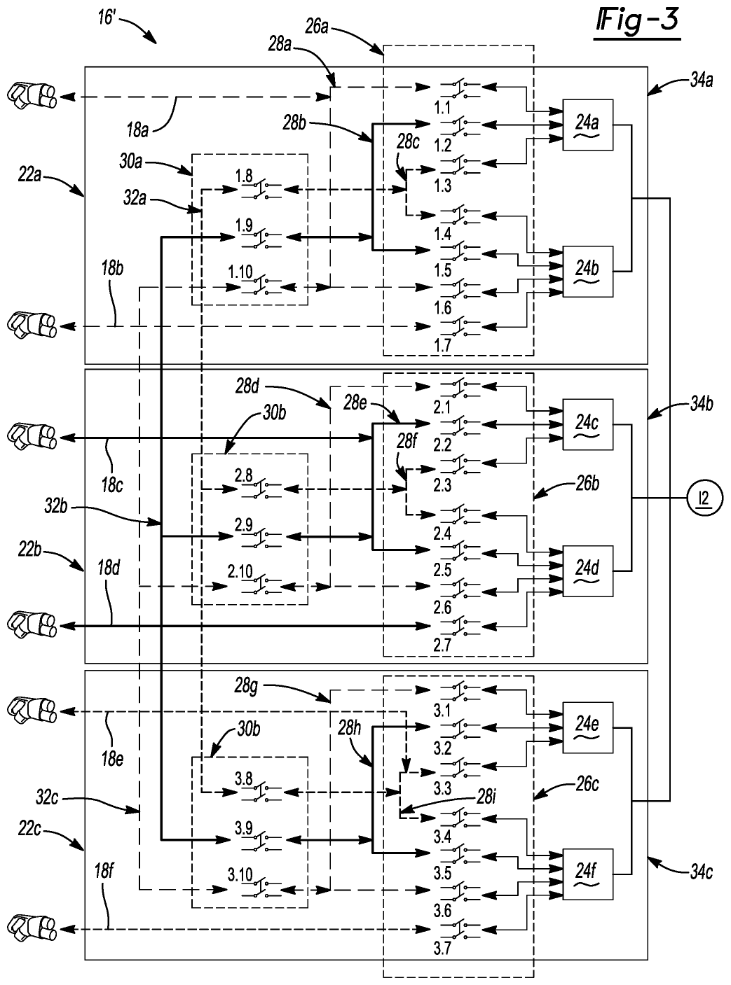

FIG. 3 depicts another implementation of the stationary vehicle battery charger 16′ distributed among a plurality of individual dispensers 34a-34c each dispenser 34a-34c providing one or more charging cables 18a-18f capable of electrically connecting to BEVs 14 to charge the BEV battery 20. Each dispenser 34a-34c can include one or more power modules 24a-24f each receiving AC voltage from the electrical grid 12 and also electrically coupled to a charging cable 18a-18f. Each dispenser 34 can be enclosed within its own housing 22a-22c. In this implementation, each dispenser 34a-34c can include two power modules 24a-24f that each rectify the AC voltage into DC voltage as described above. For instance, dispenser 34a can include power modules 24a-24b, dispenser 34b can include power modules 24c-24d, and dispenser 34c can include power modules 24e-24f. The power modules 24a-24f can be electrically coupled to a primary group of switches 26a-26c that are distributed among the dispensers 34. In this implementation, power modules 24a-24b are electrically coupled to a primary group of switches 26a including switches 1.1-1.7. Power module 24a can be electrically coupled to switches 1.1-1.3 while power module 24b can be electrically coupled to switches 1.4-1.7. Power modules 24c-24d are electrically coupled to a primary group of switches 26b including switches 2.1-2.7. Power module 24c can be electrically coupled to switches 2.1-2.3 while power module 24d can be electrically coupled to switches 2.4-2.7. And power modules 24e-24f are electrically coupled to a primary group of switches 26c including switches 3.1-3.7. Power module 24e can be electrically coupled to switches 3.1-3.3 while power module 24f can be electrically coupled to switches 3.4-3.7.

Each dispenser 34a-34c can include primary module busses 28a-28i that electrically couple switches 1.1-1.7, 2.1-2.7, 3.1-3.7 within each dispenser 34a-34c. For example, dispenser 34a can include primary module bus 28a electrically coupling switches 1.1 and 1.6, primary module bus 28b electrically coupling switches 1.2 and 1.5, and primary module bus 28c electrically coupling switches 1.3 and 1.4. Dispenser 34b can include primary module bus 28d electrically coupling switches 2.1 and 2.6, primary module bus 28e electrically coupling switches 2.2 and 2.5, and primary module bus 28f electrically coupling switches 2.3 and 2.4. Dispenser 34c can include primary module bus 28g electrically coupling switches 3.1 and 3.6, primary module bus 28h electrically coupling switches 3.2 and 3.5, and primary module bus 28i electrically coupling switches 3.3 and 3.4. Switches 1.7, 2.7, and 3.7 can be directly electrically coupled to charging cables 18b, 18d, and 18f, respectively.

The switches 1.1-1.7, 2.1-2.7, 3.1-3.7 included in the primary group of switches 26a-26c can also be electrically coupled to a secondary group of switches 30a-30c. Switches 1.8-1.10, 2.8-2.10, and 3.8-3.10 in the secondary group of switches 30a-30c, respectively, can electrically couple with the power modules 24a-f through the primary group of switches 26a-26c or a secondary bus 32a-32c. In this implementation, the switches 1.8, 2.8, 3.8 can electrically couple with a secondary bus 32a. In this implementation, the switch 1.8 can electrically couple with primary module bus 28c, the switch 1.9 can electrically couple with primary module bus 28b, and the switch 1.10 can electrically couple with primary module bus 28a. The switch 2.8 can electrically couple with primary module bus 28f, the switch 2.9 can electrically couple with primary module bus 28e, and the switch 2.10 can electrically couple with primary module bus 28d. The switch 3.8 can electrically couple with primary module bus 28i, the switch 3.9 can electrically couple with primary module bus 28h, and the switch 3.10 can electrically couple with primary module bus 28g. Switch 1.10 can be electrically coupled to charging cable 18a and switch 3.8 can be electrically coupled to charging cable 18e. Secondary bus 32a can electrically couple switches 1.8, 2.8, and 3.8; secondary bus 32b can electrically couple switches 1.9, 2.9, and 3.9; secondary bus 32c can electrically couple switches 1.10, 2.10, and 3.10.

The stationary vehicle battery charger 16,16′ can be controlled in a variety of ways to deliver a variable level of electrical power through each of the charging cables 18. For example, if 180 kW is desired at charging cable 18a, power module 24a and power module 24b, along with a third power module selected from power modules 24c-24f, can be electrically connected to the charging cable 18a through the primary group of switches 26 and the secondary group of switches 30. One control scheme of several possible choices could be to render switch 3.5 of the primary group of switches 26 conductive and switch 3.9 of the secondary group of switches 30 to electrically couple power module 24f to charging cable 18a. However, other control or commands are possible. For example, eight switching tables are shown below detailing power (in kW) at a particular charging cable 18, the power (in kW) across each switch rendered conductive.

### First Example

| Charging | | | Primary | | | Secondary |
|---|---|---|---|---|---|---|
| Cable | Power | Module | Switch | | | Switch |
| 1 | 60 | 1 | 1.1 | 60 | on | 1.8 |
| 2 | 60 | 2 | 1.2 | | | 1.9 |
| | | 3 | 1.3 | | | 1.10 |
| | | | 1.4 | | | |
| | | 5 | 1.5 | | | |
| | | 6 | 1.6 | | | |
| | | | 1.7 | 60 | on | |
| 3 | 60 | | 2.1 | | | 2.8 |
| 4 | | | 2.2 | 60 | on | 2.9 |
| | | | 2.3 | | | 2.10 |
| | | | 2.4 | | | |
| | | | 2.5 | | | |
| | | | 2.6 | | | |
| | | | 2.7 | 60 | on | |
| 5 | 60 | | 3.1 | | | 3.8 |
| 6 | 60 | | 3.2 | | | 3.9 |
| | | | 3.3 | 60 | on | 3.10 |
| | | | 3.4 | | | |
| | | | 3.5 | | | |
| | | | 3.6 | | | |
| | | | 3.7 | 60 | on | |

### Second Example

| Charging | | | Primary | | | Secondary |
|---|---|---|---|---|---|---|
| Cable | Power | Module | Switch | | | Switch |
| 1 | 120 | 1 | 1.1 | 60 | on | 1.8 |
| 2 | 0 | 2 | 1.2 | | | 1.9 |
| | | 3 | 1.3 | | | 1.10 |
| | | 4 | 1.4 | | | |
| | | 5 | 1.5 | | | |
| | | 6 | 1.6 | 60 | on | |
| | | | 1.7 | | | |
| 3 | 120 | | 2.1 | | | 2.8 |
| 4 | 0 | | 2.2 | 60 | | 2.9 |
| | | | 2.3 | | | 2.10 |
| | | | 2.4 | | | |
| | | | 2.5 | 60 | on | |
| 5 | 120 | | 2.6 | | | |
| 6 | 0 | | 2.7 | | | |
| | | | 3.1 | | | 3.8 |
| | | | 3.2 | | | 3.9 |
| | | | 3.3 | 60 | on | 3.10 |
| | | | 3.4 | 60 | on | |
| | | | 3.5 | | | |
| | | | 3.6 | | | |
| | | | 3.7 | | | |

### Third Example

| Charging | | | Primary | | | Secondary |
|---|---|---|---|---|---|---|
| Cable | Power | Module | Switch | | | Switch |
| 1 | 0 | 1 | 1.1 | | | 1.8 |
| 2 | 120 | 2 | 1.2 | 60 | on | 1.9 |
| | | 3 | 1.3 | | | 1.10 |
| | | A | 1.4 | | | |
| | | 5 | 1.5 | 60 | on | |
| | | 6 | 1.6 | | | |
| | | | 1.7 | 120 | on | |
| 3 | 0 | | 2.1 | 60 | on | 2.8 |
| 4 | 120 | | 2.2 | | | 2.9 |
| | | | 2.3 | | | 2.10 |
| | | | 2.4 | | | |
| | | | 2.5 | | | |
| | | | 2.6 | 60 | on | |
| | | | 2.7 | 120 | no | |
| 5 | 0 | | 3.1 | 60 | on | 3.8 |
| 6 | 120 | | 3.2 | | | 3.9 |
| | | | 3.3 | | | 3.10 |
| | | | 3.4 | | | |
| | | | 3.5 | | | |
| | | | 3.6 | 60 | on | |
| | | | 3.7 | 120 | on | |

### Fourth Example

| Charging | | | Primary | | | Secondary | | |
|---|---|---|---|---|---|---|---|---|
| Cable | Power | Module | Switch | | | Switch | | |
| 1 | 180 | 1 | 1.1 | 60 | on | 1.8 | | |
| 2 | 180 | 2 | 1.2 | | | 1.9 | 180 | on |
| | | 3 | 1.3 | | | 1.10 | 180 | on |
| | | 4 | 1.4 | | | | | |
| | | 5 | 1.5 | 60 | | | | |
| | | | 1.6 | | | | | |
| | | | 1.7 | 60 | | | | |
| 3 | 0 | | 2.1 | 60 | on | 2.8 | | |
| 4 | 0 | | 2.2 | | | 2.9 | | |
| | | | 2.3 | | | 2.10 | 60 | on |
| | | | 2.4 | | | | | |
| | | | 2.5 | | | | | |
| | | | 2.6 | 60 | 00 | | | |
| | | | 2.7 | | | | | |
| 5 | 0 | | 3.1 | 60 | on | 3.8 | | |
| 6 | 0 | | 3.2 | | | 3.9 | 60 | on |
| | | | 3.3 | | | 3.10 | | |
| | | | 3.4 | | | | | |
| | | | 3.5 | | | | | |
| | | | 3.6 | 60 | | | | |
| | | | 3.7 | | | | | |

### Fifth Example

| | | | | |
|---|---|---|---|---|
| Charging | | | Primary | Secondary |
| Cable | Power | Module | Switch | Switch |

| | | | | | | |
|---|---|---|---|---|---|---|
| 1 | 180 | 1 | 1.1 | on | 1.8 | on |
| 2 | 0 | 2 | 1.2 | | 1.9 | |
| | | 3 | 1.3 | on | 1.10 | on |
| | | 4 | 1.4 | | | |
| | | 5 | 1.5 | | | |
| | | 6 | 1.6 | on | | |
| | | | 1.7 | | | |
| 3 | 0 | | 2.1 | on | 2.8 | |
| 4 | 180 | | 2.2 | | 2.9 | |
| | | | 2.3 | | 2.10 | on |
| | | | 2.4 | | | |
| | | | 2.5 | | | |
| | | | 2.6 | on | | |
| | | | 2.7 | on | | |
| 5 | 0 | | 3.1 | | 3.8 | on |
| 6 | 0 | | 3.2 | | 3.9 | |
| | | | 3.3 | on | 3.10 | |
| | | | 3.4 | on | | |
| | | | 3.5 | | | |
| | | | 3.6 | | | |
| | | | 3.7 | | | |

### Sixth Example

| | | | | |
|---|---|---|---|---|
| Charging | | | Primary | Secondary |
| Cable | Power | Module | Switch | Switch |

| | | | | | | |
|---|---|---|---|---|---|---|
| 1 | 180 | 1 | 1.1 | on | 1.8 | on |
| 2 | 0 | 2 | 1.2 | | 1.9 | on |
| | | 3 | 1.3 | on | 1.10 | |
| | | 4 | 1.4 | | | |
| | | 5 | 1.5 | on | | |
| | | 6 | 1.6 | | | |
| | | | 1.7 | | | |
| 3 | 180 | | 2.1 | | 2.8 | |
| 4 | 0 | | 2.2 | on | 2.9 | on |
| | | | 2.3 | | 2.10 | |
| | | | 2.4 | | | |
| | | | 2.5 | on | | |
| | | | 2.6 | | | |
| | | | 2.7 | | | |
| 5 | 0 | | 3.1 | | 3.8 | on |
| 6 | 0 | | 3.2 | | 3.9 | |
| | | | 3.3 | on | 3.10 | |
| | | | 3.4 | on | | |
| | | | 3.5 | | | |
| | | | 3.6 | | | |
| | | | 3.7 | | | |

### Seventh Example

| | | | | |
|---|---|---|---|---|
| Charging | | | Primary | Secondary |
| Cable | Power | Module | Switch | Switch |

| | | | | | | |
|---|---|---|---|---|---|---|
| 1 | 240 | 1 | 1.1 | on | 1.8 | |
| 2 | 0 | 2 | 1.2 | | 1.9 | |
| | | 3 | 1.3 | | 1.10 | on |
| | | 4 | 1.4 | | | |
| | | 5 | 1.5 | | | |
| | | 6 | 1.6 | on | | |
| | | | 1.7 | | | |
| 3 | 0 | | 2.1 | on | 2.8 | |
| 4 | 120 | | 2.2 | | 2.9 | |
| | | | 2.3 | | 2.10 | |
| | | | 2.4 | | | |
| | | | 2.5 | | | |
| | | | 2.6 | on | | |
| | | | 2.7 | on | | |
| 5 | 0 | | 3.1 | on | 3.8 | |
| 6 | 0 | | 3.2 | | 3.9 | |
| | | | 3.3 | | 3.10 | on |
| | | | 3.4 | | | |
| | | | 3.5 | | | |
| | | | 3.6 | on | | |
| | | | 3.7 | | | |

### Eighth Example

| Charging | | | Primary | | | Secondary | | |
|---|---|---|---|---|---|---|---|---|
| Cable | Power | Module | Switch | | | Switch | | |
| 1 | 360 | 1 | 1.1 | 60 | on | 1.8 | | |
| 2 | 0 | 2 | 1.2 | | | 1.9 | | |
| | | 3 | 1.3 | | | 1.10 | 360 | on |
| | | 4 | 1.4 | | | | | |
| | | 5 | 1.5 | | | | | |
| | | 6 | 1.6 | 60 | on | | | |
| | | | 1.7 | | | | | |
| 3 | 0 | | 2.1 | 60 | on | 2.8 | | |
| 4 | 0 | | 2.2 | | | 2.9 | | |
| | | | 2.3 | | | 2.10 | 120 | on |
| | | | 2.4 | | | | | |
| | | | 2.5 | | | | | |
| | | | 2.6 | 60 | on | | | |
| | | | 2.7 | | | | | |
| 5 | 0 | | 3.1 | 60 | on | 3.8 | | |
| 6 | 0 | | 3.2 | | | 3.9 | | |
| | | | 3.3 | | | 3.10 | 120 | on |
| | | | 3.4 | | | | | |
| | | | 3.5 | | | | | |
| | | | 3.6 | 60 | on | | | |
| | | | 3.7 | | | | | |

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A stationary vehicle charging system for charging batteries carried by battery electric vehicles (BEVs) comprising:
a plurality of power modules configured to receive alternating current (AC) voltage from an electrical grid and rectify the AC voltage into direct current (DC) voltage;
a primary group of switches having switches electrically coupled: to the plurality of power modules, with other switches within the primary group of switches via a plurality of primary module busses, and to a charging cable for charging a BEV; and
a secondary group of switches having switches electrically coupled to: a plurality of switches within the primary group of switches, with another charging cable for charging a BEV, and configured to electrically couple to one or more secondary busses.

2. The stationary vehicle charging system recited in claim 1, wherein the primary group of switches selectively couples the plurality of power modules directly to the charging cables and the secondary group of switches are configured to selectively couple two or more power modules to the one or more secondary busses.

3. The stationary vehicle charging system recited in claim 1, wherein the primary group of switches and the secondary group of switches can include switches having a variable electrical power.

4. The stationary vehicle charging system recited in claim 1, wherein the plurality of power modules, the primary group of switches, and the secondary group of switches are enclosed within a housing.

5. The stationary vehicle charging system recited in claim 1, wherein the plurality of power modules, the primary group of switches, and the secondary group of switches are enclosed within a plurality of housings.

6. The stationary vehicle charging system recited in claim 1, wherein the plurality of power modules comprises SiC MOSFETs.

7. A stationary vehicle charging system for charging batteries carried by battery electric vehicles (BEVs) comprising:
a plurality of power modules configured to receive alternating current (AC) voltage from an electrical grid and rectify the AC voltage into direct current (DC) voltage;
a first dispenser, including some of the plurality of power modules, having a first housing, electrically coupled to at least one charging cable for charging a BEV;
a second dispenser, including some of the plurality of power modules, having a second housing, electrically coupled to at least one charging cable for charging a BEV;
a primary group of switches in the first dispenser electrically coupled: to the plurality of power modules in the first dispenser, with other switches within the primary group of switches located in the first dispenser via a plurality of primary module busses;
a secondary group of switches in the first dispenser having switches electrically coupled to: a plurality of switches within the primary group of switches in the first dispenser and configured to electrically couple to one or more secondary busses;
a primary group of switches in the second dispenser electrically coupled: to the plurality of power modules in the second dispenser, with other switches within the primary group of switches located in the second dispenser via a plurality of primary module busses; and
a secondary group of switches in the second dispenser having switches electrically coupled to: a plurality of switches within the primary group of switches in the second dispenser and the secondary group of switches in the first dispenser.

8. The stationary vehicle charging system recited in claim 7, wherein the primary group of switches selectively couples the plurality of power modules directly to the charging cables and the secondary group of switches are configured to selectively couple two or more power modules to the one or more secondary busses.

9. The stationary vehicle charging system recited in claim 7, wherein the primary group of switches and the secondary group of switches can include switches having a variable electrical power.

10. The stationary vehicle charging system recited in claim 7, wherein the plurality of power modules comprises SiC MOSFETs.

11. A stationary vehicle charging system for charging batteries carried by battery electric vehicles (BEVs) comprising:
a first power module and a second power module configured to receive alternating current (AC) voltage from an electrical grid and rectify the AC voltage into direct current (DC) voltage;
a primary group of seven switches, such that: three of the switches are electrically coupled the first power module, four of the switches are electrically coupled to the second power module, wherein one of the switches electrically coupled to the second power module is also directly coupled to a charging cable for charging a BEV;
a plurality of primary module busses electrically connecting the primary group of seven switches;
a secondary group of three switches electrically coupled to the plurality of primary module busses and configured to electrically couple to one or more secondary busses.

12. The stationary vehicle charging system recited in claim 11, wherein the primary group of switches selectively couples the plurality of power modules to the charging cables and the secondary group of switches are configured to selectively couple two or more power modules to the one or more secondary busses.

13. The stationary vehicle charging system recited in claim 11, wherein the primary group of switches and the secondary group of switches can include switches having a variable electrical power.

14. The stationary vehicle charging system recited in claim 11, wherein the plurality of power modules, the primary group of switches, and the secondary group of switches are enclosed within a housing.

15. The stationary vehicle charging system recited in claim 11, wherein the plurality of power modules, the primary group of switches, and the secondary group of switches are enclosed within a plurality of housings.
